(19) United States
(12) Patent Application Publication
(10) Pub. No.: US 2018/0118121 A1
(43) Pub. Date: May 3, 2018

(54) AUTOMOTIVE INTERIOR COMPONENT SUCH AS A TAMBOUR DOOR

(71) Applicant: Inoac USA, Inc., Troy, MI (US)

(72) Inventor: James Vincent Gorman, JR., Holly, MI (US)

(21) Appl. No.: 15/798,998

(22) Filed: Oct. 31, 2017

Related U.S. Application Data
(60) Provisional application No. 62/415,106, filed on Oct. 31, 2016.

(51) Int. Cl. B60R 7/04; B29C 69/02

(52) U.S. Cl. CPC B60R 7/04; B29C 51/10; B29C 69/02

(57) ABSTRACT

An automotive center console includes a console body having an interior cavity accessible through an opening and a tambour door for opening and closing the opening. The tambour door includes a vacuum formed cover, a substrate including a plurality of generally parallel slats allowing the tambour to flex to a curved shape and an foam layer in between the substrate and the cover. The foam layer is formed using a foam in place (FIP) process.

### CROSS-REFERENCE TO RELATED APPLICATIONS

This application claims the benefit of U.S. provisional application No. 62/415,106, filed 31 Oct. 2016, which is hereby incorporated by reference as though fully set forth herein.

### BACKGROUND

### a. Technical Field

This application relates generally to an automotive interior component and particularly to a tambour door with skin and foam cover.

### b. Background Art

Automotive interiors are provided with various features and components to improve the comfort and convenience of vehicle occupants. For example, many automotive vehicles include a center console disposed between the driver and passenger seats in the front passenger compartment of the vehicle. Such center consoles may perform many functions, such as, for example only, operating as an armrest and providing a compartment for storage.

Such consoles may comprise a console base secured to the floor which defines a storage cavity to store and retain items during travel. Access to the storage cavity may be made through an opening in the console base leading to the cavity. Such consoles typically include a door that can be moved between open and closed positions to selectively allow and disallow access to the storage cavity. One kind of door is a tambour door (sometimes called a roller door), which may include a substrate featuring a plurality of horizontal slats that are retained in a track. A cover may be affixed to the substrate and include a cushion for an armrest. The substrate is configured so that the slats can flex so that when the tambour door is moved to open or close the center console opening, the tambour door itself flexes to assume the shape of the track and/or the opening. The track can comprise a curved shape thereby allowing the tambour door to be adapted to a curved opening of a storage compartment or to allow the tambour door to be stowed in a curved shape, for example only.

A known tambour door includes a cushion having an integral outer skin that forms a show surface. However, it would be desirable to provide a tambour door that allows greater flexibility in outward appearance.

This background description is set forth below for the purpose of providing context only. Therefore, any aspects of this background description, to the extent that it does not otherwise qualify as prior art, is neither expressly nor impliedly admitted as prior art against the instant disclosure.

The foregoing discussion is intended only to illustrate the present field and should not be taken as a disavowal of claim scope.

### SUMMARY

An automotive interior component, such as an automotive center console in an embodiment, includes a tambour door. Embodiments consistent with the instant teachings provides are sturdier and provide greater flexibility in the types of externally visible features. For example only, such externally visible features may grooving, stitching, and the like. In an embodiment, the automotive interior component includes a console body having an interior cavity with an opening for access to the interior cavity and a tambour door movable between at least a first position where the tambour door closes the opening and a second position where the tambour door allows access through the opening for access to the interior cavity.

The tambour door, in an embodiment, includes a substrate comprising a plurality of slats generally perpendicular to a longitudinal axis of the substrate, where the slats are configured to reside in and guide the movement of the tambour door along a track system disposed in the console body. The tambour door further includes a cover coupled to the substrate and having a first, externally visible surface and a second, opposing surface facing the substrate. The tambour door includes a foam layer between the second surface of the cover and the substrate. At least a portion of the substrate is configured to flex from a first, straight configuration to a second, flexed configuration. In an embodiment, the cover further includes an elastic membrane affixed to the second surface (i.e., the “back” of the cover) that is configured to urge the substrate from the second, flexed configuration to the first, straight configuration. In an embodiment, the cover may be vacuum formed to allow for a wide variety of visible features. In an embodiment, the substrate may be an injection molded component and the foam layer may be produced in place. In other words, the foam layer may be produced by introducing a mixture in between the cover and the substrate and allowing the mixture to expand and cure to form the foam layer.

A method of manufacturing an automotive interior component is also presented.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a diagrammatic view of an interior of an automotive vehicle showing a center console having a tambour door according to the instant teachings.

FIGS. 2-4 are diagrammatic views of the center console of FIG. 1 having a pair of opposing tambour doors, showing, respectively, both tambour doors being in the closed position, the upper tambour door being in an open position, and the lower tambour door being in an open position.

FIG. 5 is a diagrammatic, exploded view of the constituent parts of a tambour door, in an embodiment, including a substrate, a cover, an elastic membrane, and a user handle.

FIG. 6 is a diagrammatic view of the substrate of FIG. 5 in a deflected configuration.

FIG. 7 is a diagrammatic view of a tambour door including the substrate of FIG. 6 shown in a deflected configuration.

FIG. 8 is a simplified, cross-sectional view of the tambour door of FIG. 5 in an initial stage of processing.

FIG. 9 is a simplified view of the tambour door of FIG. 5 in a completed stage of processing, further showing a second tambour door in an opposed arrangement.

FIG. 10 is a simplified, cross-sectional view of the dual tambour doors of FIG. 9 taken substantially along lines 10-10 in FIG. 9.

FIG. 11 is a simplified, cross-sectional view of the dual tambour doors of FIG. 9 taken substantially along lines 11-11 in FIG. 9.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It will be further appreciated that for conciseness and clarity, spatial terms such as “vertical,” “horizontal,” “up,” and “down” may be used herein with respect to the illustrated embodiments.

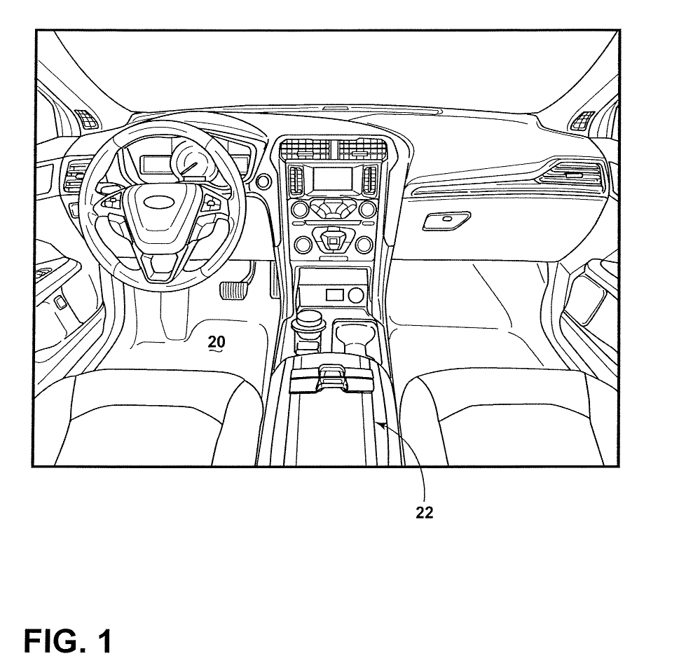

FIG. 1 is a view of an interior compartment or cabin 20 of an automotive vehicle showing a center console 22 having a tambour door according to the instant teachings A tambour door can be used in an interior of an automotive vehicle, such as a door/cover/lid for a center console compartment. In embodiments, the tambour door can also be utilized as an armrest. Embodiments herein can provide an alternative to conventional center console armrest lid structures.

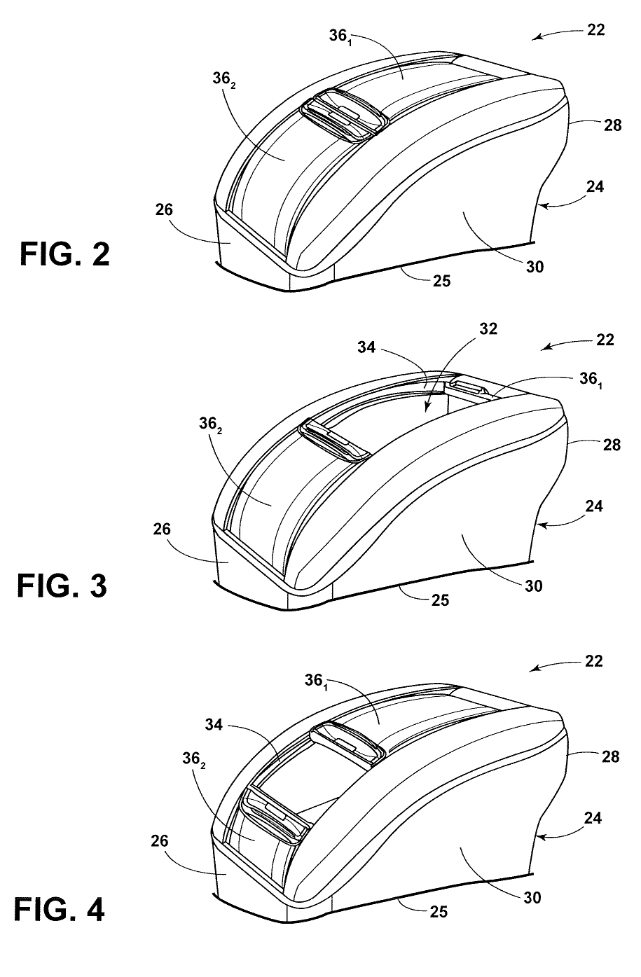

FIG. 2 illustrates in greater detail the center console 22 as shown in FIG. 1, which has a pair of opposing tambour doors designated 36₁ and 36₂. The center console 22 includes a console body 24 having a base 25 (which may be a base wall), a front wall 26, a rear wall 28, and a pair of opposing side wall 30 (only the near wall 30 visible in FIG. 2). The walls 26, 28, and 30 extend from base 25 to define an interior cavity 32 (best shown in FIG. 3). The interior cavity 32 may be used for storage of various items, as known. As also shown, the upper (visible) surface of either tambour door 36₁, 36₂ may be used as an armrest for either the driver or the front passenger of the automotive vehicle. The center body 24 further includes an opening 34 (best shown in FIG. 3). In FIG. 2, both tambour doors 36₁ and 36₂ are in a first position that closes off the opening 34, impeding access to the interior 32.

FIG. 3 is similar to FIG. 2, but shows tambour door 36₁ in a second (open) position away from the first position of FIG. 2, which allows access to the interior cavity 32 through opening 34. The tambour door 36₂ remains in the first, closed position.

FIG. 4 is similar to FIGS. 2-3, but shows tambour door 36₁ in the first (closed) position but now tambour door 36₂ is in a second (open) position which also allows access to the interior cavity 32 through opening 34.

In FIGS. 2-4, each of the tambour doors 36₁, 36₂ can be moved to any one of a plurality of positions in between the first (closed) position and the second (fully open) position.

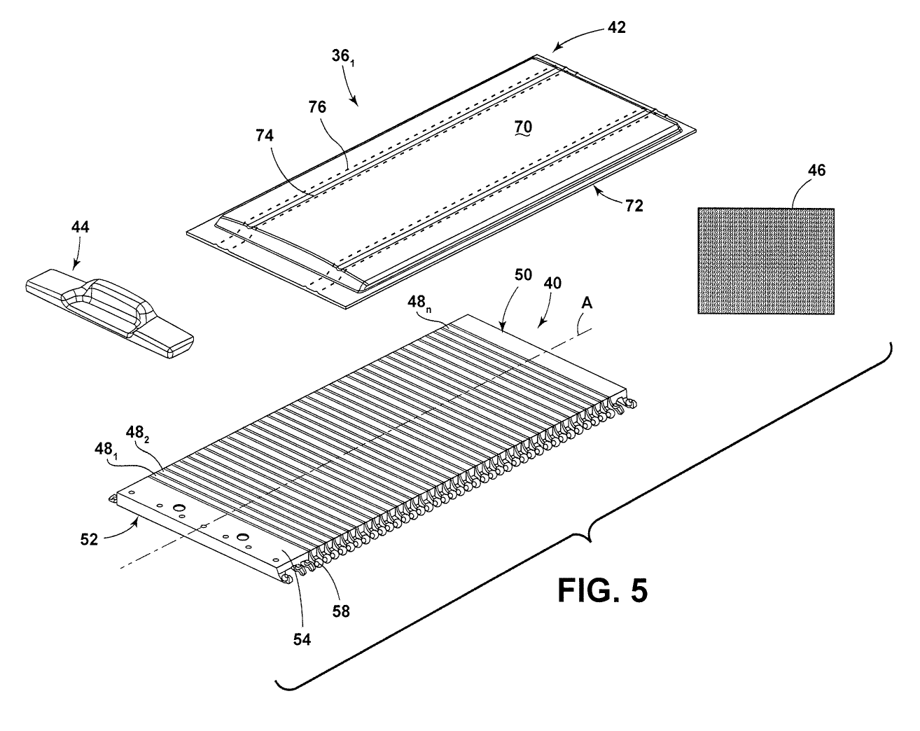

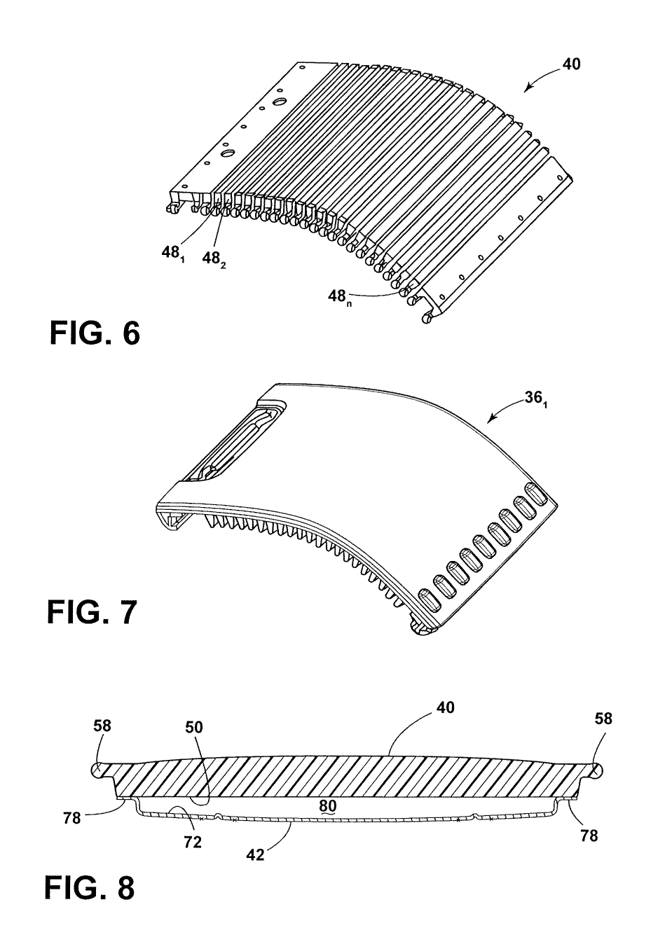

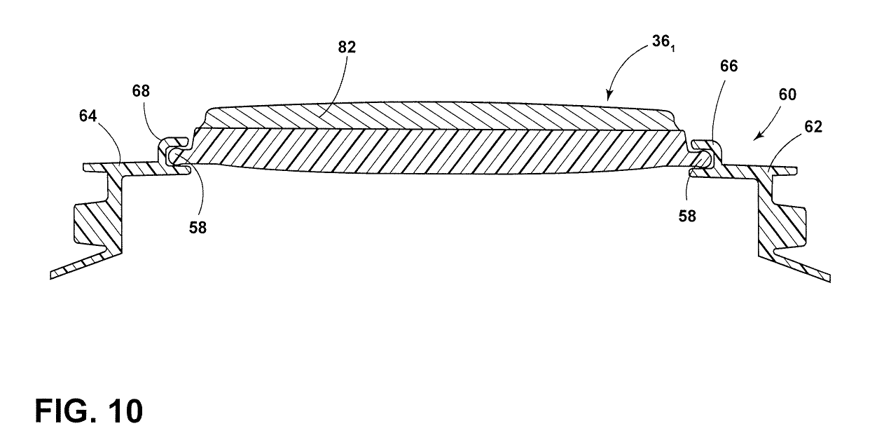

FIG. 5 is an exploded view of the constituent parts of a tambour door, such as tambour door 36₁ in an embodiment. As shown, the tambour door 36₁ includes a substrate 40, a cover or skin 42, a handle 44, and an elastic membrane 46. The completed tambour door 36₁ also includes a relatively flexible and/or soft foam layer 82 disposed between the cover 42 and the substrate 40, and which is best shown in FIG. 10.

The substrate 40 provides a structural foundation for the tambour door 36₁ and may extend along a longitudinal axis A. In the illustrative embodiment, the substrate 40 includes a plurality of members or slats 48₁, 48₂, . . . , 48ₙ, a first, generally planar top surface 50 and an opposing second surface 52. The substrate 40 also includes a first longitudinal end 54 and a second, opposing longitudinal end 56. As shown in FIG. 5, the substrate 40 may assume a first configuration in which the first (top) surface 50 is generally flat or planar.

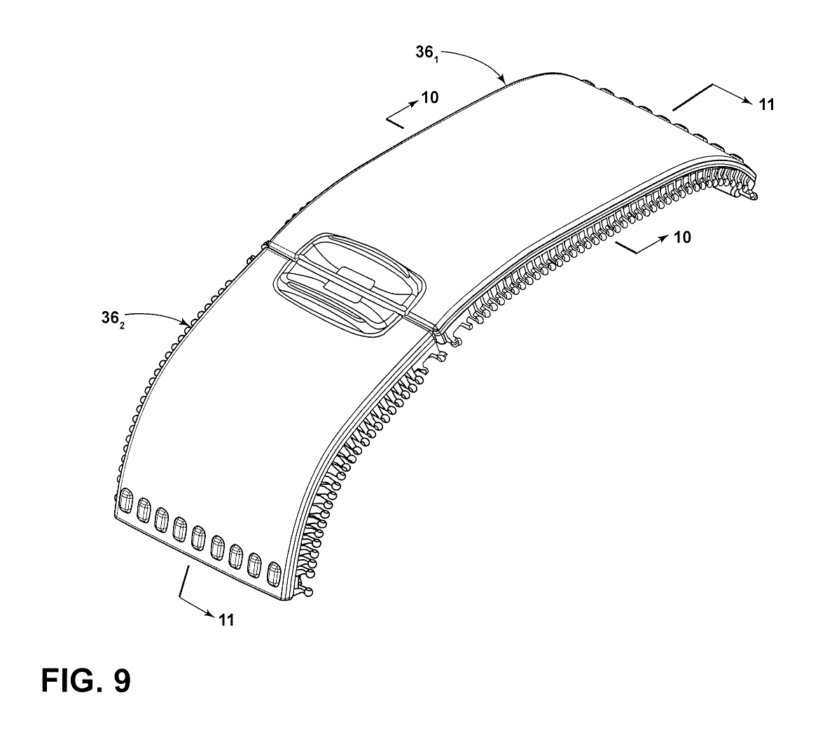

Each of the slats 48₁, 48₂, . . . , 48ₙ is generally parallel to each and perpendicular to the longitudinal axis A. In an embodiment, the slats 48₁, 48₂, . . . , 48ₙ may be connected to each other by way of a living hinge membrane in order to stabilize and align the slats 48₁, 48₂, . . . , 48ₙ (i.e., the structural cross-members). Each of the slats 48₁, 48₂, . . . , 48ₙ is configured to deflect and/or rotate relative to adjacent slats 48₁, 48₂, . . . , 48ₙ so as to allow at least a portion of the substrate 40 to flex and assume a second configuration in which the substrate has flexed and is thus curved in shape. FIG. 6 shows substrate 40 in the second configuration. By virtue of this functionality, the tambour door 36₁ can also assume a first straight (un-flexed) configuration as well one or more second (curved shape) configurations, such as shown in FIG. 7 as well as FIG. 9.

With continued reference to FIG. 5, the substrate 40 is also configured such that the slats 48₁, 48₂, . . . , 48ₙ reside in and guide the movements of the tambour door 36₁ along a track system disposed in the console body. To facilitate this movement, each of the slats 48₁, 48₂, . . . , 48ₙ includes a respective projection 58 on laterally opposing ends. In an embodiment, the projections 58 may be spherical or hemispherical in shape and sized to fit in a respective track. With reference to FIG. 10, a track system 60 is shown that is disposed in the center console body 24 and which includes a first track 62 and a second track 64 disposed opposite of the tambour door 36₁. In the illustrated embodiment, the first track 62 includes a first U-shaped channel 66 configured in size to adequately receive and retain the projections 58 described above. Likewise, the second track 64 includes a second U-shaped channel 68 also configured in size to adequately receive and retain the projections 58 described above. The first and second tracks 62 and 64 are configured so as to allow the tambour door 36₁ to move along the opening 32 of the center console 22—thereby opening and closing opening 32.

In an embodiment, the substrate 40 may comprise polypropylene material although other engineering plastics having sufficient strength and rigidity may be used. In an embodiment, the substrate 40 may comprise polypropylene material containing a mineral filler, such as talc, which increases a flexural modulus of elasticity, dimensional stability and thermal resistance. In an embodiment, the substrate 40 may comprise a material commercially available under the trade designation XENOPREN PP-TD-20 (e.g., containing 20% talc). The substrate 40 may comprise an injection molded component.

In an embodiment, an alternate material may be used for substrate 40. For example only, thermoplastic polyolefin (TPO) may be used, which consists of a blend of polypropylene (PP), an impact modifier, and a filler, such as talc.

FIG. 5 also shows the cover 42, which is coupled to the substrate, for example through a foam layer 82 via a foam-in-place (FIP) process to be described below. The cover 42 includes a first, externally-visible surface 70 and a second, opposing surface 72. In an embodiment, the surface 72 faces the substrate 40. The visible surface 70 may include one or more surface features that are aesthetically pleasing, for example only, surface grooves 74 and/or stitching 76.

The cover 42 further includes a coated knit stretch backing or elastic membrane 46 which is affixed to the second surface 72. The membrane 46 is elastic and/or resilient and provides flexibility to the tambour door 36₁ and also provides a restorative function that tends to return or otherwise urges the cover 42—and thus also the substrate and overall the tambour door 36₁—from the above-mentioned second, flexed, curved shape configuration to the above-mentioned first, relatively straight, un-deflected (un-flexed) configuration.

The cover 42 may comprise a relatively thin (e.g., 18 1 mm or so) sheet of thermoplastic material, such as a sheet of polyvinyl chloride (PVC) material. In an embodiment, a PVC cover stock (1.2 mm thick) with a laminated elastic membrane backing may be used. For example only, such PVC cover stock with laminated elastic membrane backing may be a component commercially available under model number PL700-T (High Stretch 1.2 mm PVC) from Canadian General Tower (CGT), Cambridge, Ontario, Canada. It should be understood, however, that alternatives may be used. For example only, alternative cover stock materials include but are not limited to TPO (Thermoplastic Olefin), TPU (Thermoplastic Polyurethane) and TPE (Thermoplastic Elastomer), which are common cover stock materials utilized in automotive interior applications.

Vacuum Forming. In an embodiment, the cover 42 may be a vacuum formed (VF) component, which allow a greater variety of cosmetic finishes for the visible surface 70, especially compared to a known tambour door approach that uses a self-skinning approach. In this regard, the vacuum forming process, which should be understood to be a preliminary process to yield the cover 42 shown in FIG. 5.

The vacuum forming process begins with providing a flat sheet of thermoplastic material (not shown), for example only, PVC material as mentioned above. The flat sheet may include a first, visible surface that include a variety of cosmetically, aesthetically pleasing visible feature such as grooves, stitching as well as other surface features as known in the art (e.g., grain features). The sheet is positioned relative to a mold component having the desired shape defining the cover 42. The sheet is then heated through any of known heating approaches, thereby softening the thermoplastic material. Next, in a negative vacuum forming embodiment, a vacuum is established through the mold component, thereby drawing the softened sheet against the mold component resulting in a final components having the desired shape. An exemplary vacuum forming process may be seen by reference to U.S. application Ser. No. 11/043,231, filed 27 Jan. 2005, published as United States patent publication no. 2005/0212181 to Evans et al., hereby incorporated by reference as though fully set forth herein.

With continued reference to FIG. 5, the handle 44 may comprise an injection molded component comprising a suitable plastic, such as ABS (acrylonitrile butadiene styrene) plastic material. The handle 44 may be secured to the substrate using a suitable fastening approach, such as, for example, using screws to secure the handle 44 to the substrate 40.

Foam in Place (FIP). The tambour door 36₁ may be made using a so-called foam in place (FIP) process via open pour of foam materials. In the embodiment, the cover 42 as formed is generally concave in respect of the second surface 72 to thereby define a generally C-shape or cup shape component.

FIG. 8 is a cross-sectional view of the tambour door of FIG. 5 in an initial stage of processing. The C-shaped cover 42 may be inverted and disposed in a first mold component which is a first half of a mold (not shown) for the foam-in-place process. The tambour door substrate 40 may be positioned in a second mold component which is the other half of the mold. The cover 42 is disposed in the mold half so as to expose the second surface 42. Further, the substrate 40 is disposed in the other mold half so as to expose the first, planar surface 50. The cover 42 may include a flange portion 78 or the like around its perimeter configured to contact a corresponding engagement surface on the tambour door substrate 40 when the two mold halves are closed, as shown in FIG. 8. When the two mold haves are closed, the second surface 72 of the cover 42 and the first surface 50 of the substrate 40 define a volume 80 in which the foam layer 82 will be formed.

Before the two mold halves are closed, however, a predetermined amount of a foam material in a first, generally liquid state is introduced into a concavity of the now-inverted cover 42 (i.e., an open pour of the foam material). In an embodiment, the foam material comprises a mixture of two or more reactive components having a predetermined first volume, which produces a desired end-produce of a polyurethane foam having a second, larger volume. The second, larger volume of the PU foam is sufficient to substantially occupy the volume 80 between the substrate 40 and the cover 42. In embodiment, the polyurethane foam has a polyurethane foam density of approximately 0.157 (g/cm³), which density is measured following foam cure. In an embodiment, the polyurethane foam consists of two chemical (reactive) components as mentioned above, isocyanate and polyol. It should be understood that the above density is exemplary only. For example, a typical foam density target for automotive interior trim applications may be about 0.13 g/cm³.

After the above-mentioned mixture is introduced into the concavity of the cover 42, the mold halves are closed so that the cover 42 and the substrate 40 assume the spatial relationship shown in FIG. 8. The foam material then expands from the first volume (as liquid introduced) to a larger, second volume to occupy the volume 80. After a predetermined time period has passed, the PU foam in volume 80 cures to thereby define the foam layer 82. The tambour door 36₁ may then be removed from the mold and finished according to known practices. For example, excess portions of the cover 42 (e.g., perimeter) may be trimmed and/or finished to the substrate 40 according to known practice.

Finally, the one or more tambour doors 36₁, 36₂ (made same process as the tambour door 36₁) may then be applied/assembled to an automotive interior component such as the above center console.

FIG. 9 is an isometric view of the tambour door of FIG. 5 in a completed stage of processing as well as a second tambour door in an opposed arrangement such as shown in FIGS. 2-4.

FIG. 10 is a cross-sectional view of the dual tambour doors of FIG. 9 taken substantially along lines 10-10 in FIG. 9.

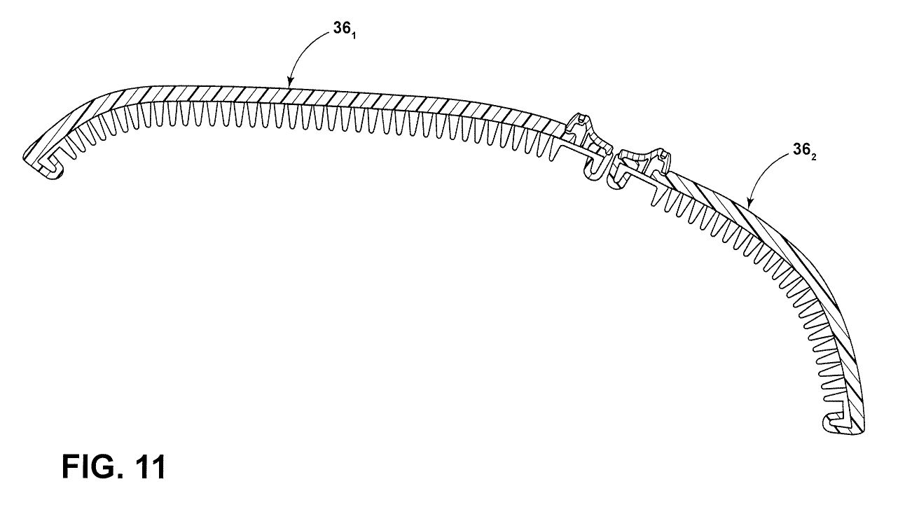

FIG. 11 is a cross-sectional view of the dual tambour doors of FIG. 9 taken substantially along lines 11-11 in FIG. 9.

Although only certain embodiments have been described above with a certain degree of particularity, those skilled in the art could make numerous alterations to the disclosed embodiments without departing from the scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other.

It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

What is claimed is:

1. An automotive interior component, comprising:
a console body having interior cavity with an opening for access to said interior cavity; and
a tambour door movable between first and second positions to open and close said opening, said tambour door including a substrate comprising a plurality of slats generally perpendicular to a longitudinal axis of said substrate wherein said slats are configured to reside in and guide the movement of said tambour door along a track system disposed in said console body, a cover coupled to said substrate and having a first, externally visible surface and a second, opposing surface facing said substrate, and a foam layer between said second surface of said cover and said substrate;
at least a portion of said substrate being configured to flex from a first, straight configuration to a second, flexed configuration, said cover having an elastic membrane affixed to said second surface thereof configured to urge said substrate from said second, flexed configuration to said first, straight configuration.

2. The automotive interior component of claim 1 wherein said slats of said substrate are generally parallel and are configured to rotate with respect to each to thereby allow said substrate to flex to said second, flexed configuration.

3. The automotive interior component of claim 1 wherein said substrate comprises polypropylene material.

4. The automotive interior component of claim 3 wherein said polypropylene material further comprises a predetermined amount of mineral filler.

5. The automotive interior component of claim 4 wherein said mineral filler comprises talc.

6. The automotive interior component of claim 1 said cover comprises polyvinyl chloride (PVC).

7. The automotive interior component of claim 1 wherein said first, visible surface of said cover includes at least a first visible feature comprising a stitching pattern.

8. The automotive interior component of claim 1 wherein said tambour door is a first tambour door, further comprising a second tambour door configured to close said opening.

9. The automotive interior component of claim 1 further comprising a handle coupled to said substrate.

10. A method of manufacturing a tambour door, comprising:
forming a cover comprising thermoplastic material having a first, externally visible surface and a second, opposing surface wherein said cover is concave in respect of said second surface;
providing a substrate extending along a longitudinal axis and having a plurality of slats generally perpendicular to said longitudinal axis wherein said slats are configured to reside in a track system to guide movement of said tambour door, said substrate having a generally planar first surface and an opposing second surface;
disposing said cover in a first mold component so as to expose said second surface of said cover and disposing said substrate in a second mold component so as to expose said first surface of said substrate ;
introducing a foam material in a first state into a concavity of said cover defined by said second surface;
closing said first mold component relative said second mold component such that at least a portion of said second surface of said cover engages said first surface of said substrate; and
opening said first mold component relative to said second mold component when said foam materials is in a second state that is expanded relative to said first state, said foam material substantially occupying said concavity.

11. The method of claim 10 wherein forming said cover comprises:
providing a thermoplastic sheet;
heating said thermoplastic sheet; and
vacuum forming said heated sheet into a desired shape defining said cover.

12. The method of claim 11 wherein vacuum forming is negative vacuum forming.

13. The method of claim 11 further comprising providing a visual feature on said first surface of said thermoplastic sheet selected from the group comprising stitches, grooves, contoured surface, and grained surface.

14. The method of claim 11 wherein said thermoplastic sheet comprises polyvinyl chloride (PVC).

15. The method of claim 14 wherein providing said substrate comprises:
injection molding said substrate using polypropylene (PP) material.

16. The method of claim 14 wherein introducing said foam material comprises pouring a liquid mixture having a first volume into said cover which produces a polyurethane (PU) foam having a second volume that is greater than said first volume.

17. The method of claim 16 wherein said second volume is sufficient to substantially occupy the space between said cover and said substrate.

18. The method of claim 10 further comprising trimming an excess amount of said cover.

19. The method of claim 10 further comprising applying said tambour door to an automotive interior component.

20. The method of claim 19 wherein said automotive interior component comprises an automotive center console.
